(19) United States
(12) Patent Application Publication
(10) Pub. No.: US 2002/0167131 A1
(43) Pub. Date: Nov. 14, 2002

(54) BEARING ISOLATOR

(76) Inventors: DAVID C. ORLOWSKI, MILAN, IL (US); THOMAS D. COE, MILAN, IL (US)

Correspondence Address: ROCKEY MILNAMOW & KATZ LTD, TWO PRUDENTIAL PLAZA, SUITE 4700, CHICAGO, IL, 60601

(21) Appl. No.: 09/428,982

(22) Filed: Oct. 28, 1999

(51) Int. Cl. F16J 15/34

(52) U.S. Cl. 277/371

(57) ABSTRACT

A bearing isolator mechanism is adapted to use with a machinery housing having rotatable shaft protruding through the housing. The isolator mechanism comprises a stator surrounding said shaft and being affixed to the housing, the stator having a single groove or multiple deep grooves in the stator extended radially from said shaft. The wall ends of the stator forming the sides of the deep groove are located in as close proximity as mechanically possible to the shaft. The groove is as deep and wide as possible within the mechanical constraints of the stators width and the material. The groove in said stator has a hole or orifice in the stator wall that connects said groove in said housing at the lower extremity of the groove in the stator. The hole or holes should interrupt the grooves outer diameter by one-half the diameter of hole or orifice. The holes if more than one, may be elongated and spaced around the circumference of the stator to permit positioning and rotation of the housing with relationship to the shaft.

### BACKGROUND OF THE INVENTION

This invention relates generally to shaft sealing devices and more particularly to seals which will effectively seal lubricant in a housing, not only during normal operating conditions, but also under the unusual conditions of high oil levels or turbulence of the oil.

Currently, with usually high oil or lubricant levels i.e., levels approaching the outer diametric surface of the shaft, the effectiveness of the drain, which was located near the shaft and an inclined diminished trough. Under normal or ideal conditions lubricant was stripped from the shaft, collected in the labyrinth collection grooves of the seal and drained back to the oil sump by gravity. Under high lubricant levels the drain often became non-functional.

In the case of a high level of lubricant, lubricant stripped from the shaft was then transferred outward along the shaft to the rotor/stator interface with the result being a leaking seal i.e., leaking fluids to the outer side of the seal.

Another condition, which caused leaking seals, was high lubricant turbulence. This turbulence was caused by meshing gears or cylindrical roller bearings agitating the oil and the oil would then impinge on the exit drain trough and inhibit downward or inward flow of the lubricant down the trough's slope and transfer along the shaft with a leaking seal being the result.

The location of the drain or trough close to the shaft also caused leakage in the cases where pressure lubricated sleeve bearings for being utilized. The pressurized lubricants at the shaft to bearing interface tended to travel parallel to and along the shaft and impinge on the slope of the drain and climb the slope thereby leaking out of the seal.

### SUMMARY OF THE INVENTION

The present invention is a improvement over the prior art in that the leakage of lubricant is eliminated during high oil levels or high levels of turbulence or axial impingement as well as during normal operation.

The invention has incorporated a large collection groove or grooves in the stator with a improved location of the drain. This collection groove should be as deep and wide as possible to maximize the collection of lubricant. The lubricant in the collection groove is drained to the sump with an orifice located at the lowest point of the seal and is also as far away from the shaft as possible.

Present drain holes are located close to the shaft and the inner diameter of the stator as contrasted to their location this invention wherein the drains are close to the outer diameter of the stator.

If no external contaminants are present or need to be rejected, the seal may comprise only the stator with its collection groove or grooves and a drain hole & trough at the outer extremity of the stator.

The stator presents a blank wall to impinging lubricant. The sides of groove are located radially close to the shaft which also acts to restrict the flow of lubricant along the shaft. More lubricant may be collected in a larger collection groove to aid the sealing action.

### DESCRIPTION OF THE DRAWINGS

FIG. 1—shows a cross-sectional view of the seal with rotor in a housing on a shaft.

FIG. 2—is a view of the wall of the collecting groove with drain ports.

FIG. 3—is a cross-sectional view of the stator seal without the rotor present.

FIG. 4—is a cross-sectional view of the seal with a rotor in a housing on a shaft without an ejection port.

### DESCRIPTION OF THE PREFERRED EMBODIMENT

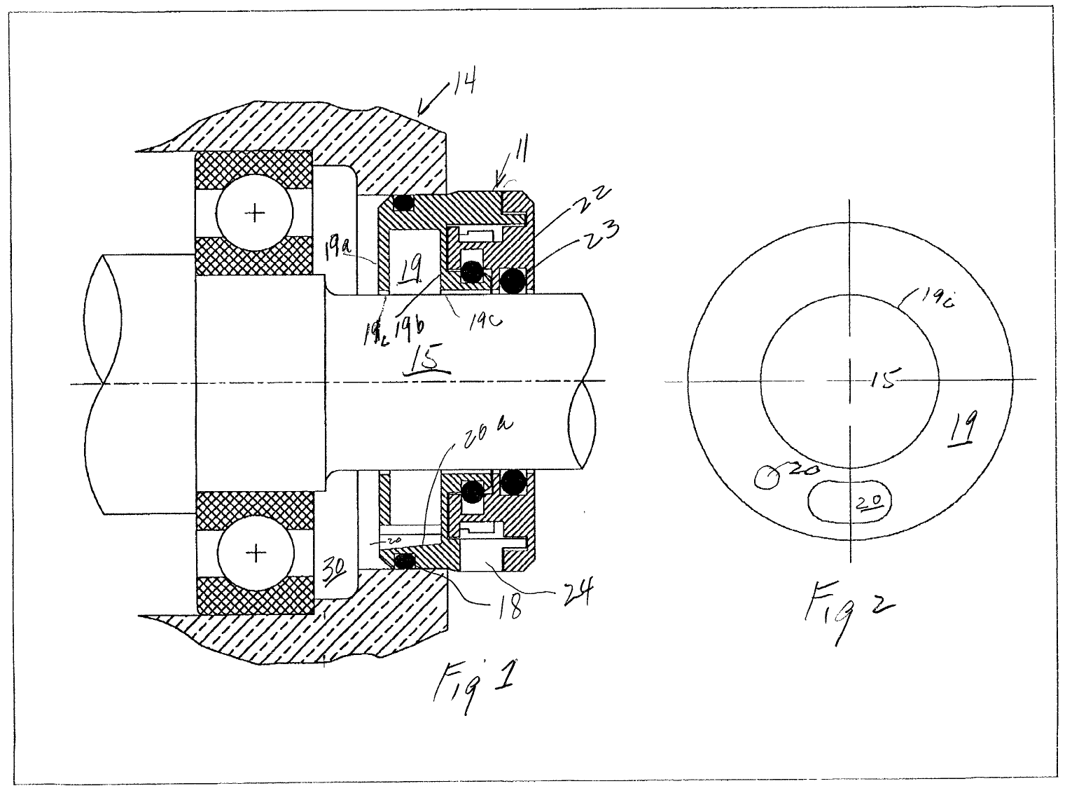

Referring to FIG. 1 which shows the seal 11 including rotor 12 and stator 13 in housing 14. Shaft 15 has a bearing 16 mounted on shaft 15. Rotor 12 is rotated with shaft 15 by o-ring 17. Stator 13 is affixed to the housing 16 by seal 18. Stator 13 also has a groove 19 formed by sidewalls 19a and 19b. This groove 19 should be as deep and wide as possible depending upon the radial cross-section and the material characteristics of the stator 11.

There may be more than one groove 19, however all material limitations must be observed with a plurality of grooves i.e., the radial cross section and material characteristics must still be limiting factors as to the depth and width of the groove.

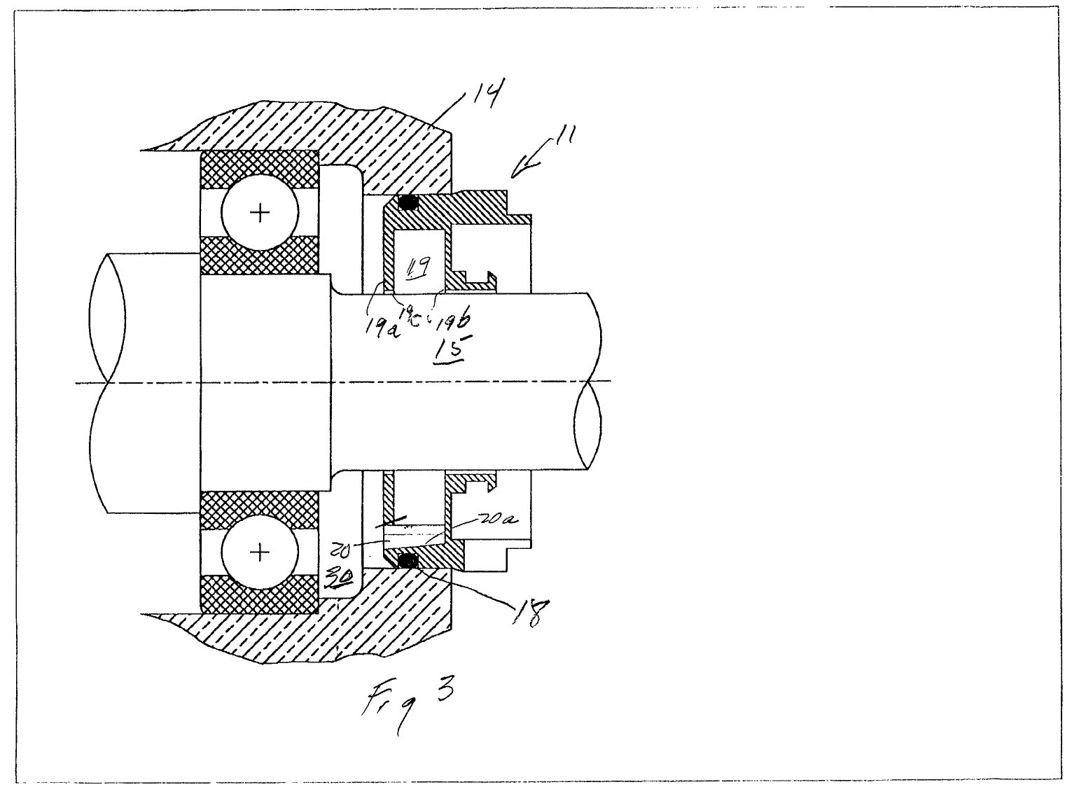

There is an axial slot 20 incorporated to the stator 13 at the outer radial limits of groove 19. This slot 20 or hole includes a sloping surface or trough 20a to carry lubricant to the sump 30. The slot may be circular or elongated around the periphery of the stator wall 19a. Slot 20 may be a plurality of circumferential slots as shown in FIG. 2. Slot 20 intersects and penetrates into groove 19 at an angle to the shaft 15 and intersects the diameter of groove 19 at the outer diameter, approximately one-half of the diameter of the hole or orifice.

Slot 20 is as far away from shaft 15 and the stator 11 interface as possible. The inner radial surfaces of stator groove walls 19a and 19b should be as close to shaft 15 as possible. The radial dimension between shaft 15 and the seal faces 19c should be in the range of 0.005 inches per inch of shaft diameter. As shown in FIG. 2 the stator may be rotated while always providing a fixed downward position of at least one drain hole for the draining of the lubricants back to the sump 30.

The contaminant expulsion is not assured when rotation of this seal occurs. However this invention provides that in one configuration, the rotor 12, that the diameter at interference of rotor 12 with stator 13 is greater than the diameter of stator 13. This differential creates a pumping action of contaminants outwardly at the rotor/stator interface because of ever increasing diameter in the direction of the intended path of contaminants expulsion and exclusion.

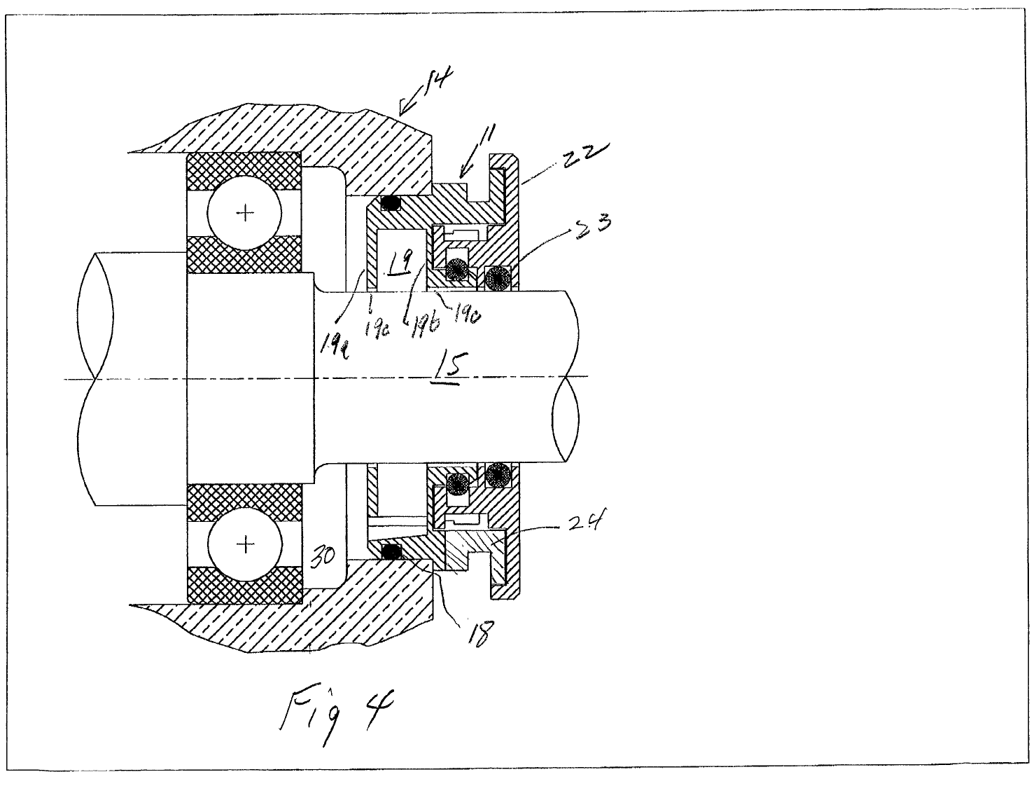

As shown if FIG. 3, the stator 13 can operate alone where no external contaminants are to be encountered. The seal consisting only of stator 13 can be simplified in this case as no interplay or labyrinth required between the rotor and stator parts. This can greatly reduce costs of oil retention, if retention is the only requirement.

Having described the preferred embodiment, other features of the present invention will undoubtedly occur to those versed in the art, as will numerous modifications and alterations in the embodiments of the invention illustrated, all of which may be achieved without departing from the spirit and scope of the invention as defined in the appended claims.

What is claimed is:

1. An isolator mechanism for use with a housing having a bearing with lubricant in the housing and a shaft protruding through the housing, the isolator comprising:
a) a stator affixed to the housing and surrounding the shaft;
b) said stator having a radial groove formed therein with the walls of said groove extending between said housing and said shaft;
c) the exterior surface of a first wall of said groove facing the interior of the housing;
d) an axial hole in said first wall at the lower extremity of said first wall from said shaft connecting said groove to said housing.

2. An isolator accordance with claim 1, wherein said radial groove is more that one-half the radially dimension of said stator.

3. An isolator accordance with claim 1, wherein said hole in said first wall of stator includes a axially sloping surface connecting said radial groove to said housing.

4. An isolator accordance with claim 3, wherein said hole and said sloping surface are elongated.

5. An isolator accordance with claim 3, wherein said hole and said sloping surface are milled in said first wall.

6. An isolator accordance with claim 1, wherein the inside diameter of said stator is proportional to the diameter of said shaft.

7. An isolator accordance with claim 6, wherein the proportion of said stator to said shaft is 0.005 inches per inch of shaft diameter.

8. An isolator accordance with claim 4, wherein said hole and said sloping surface are elongated circumferentially.

9. An isolator mechanism for use with a housing having a bearing with lubricant in a housing and a shaft protruding through the housing, the isolator comprising:
a) a stator affixed to the housing and surrounding the shaft;
b) said stator having a plurality of radial grooves formed therein with the walls of said grooves extending between said housing and said shaft;
c) the exterior surface of a first wall of said grooves facing the interior of the housing;
d) an axial hole in said in said walls at the extremity of said walls from said shaft connecting said grooves to said cavity.

10. An isolator accordance with claim 9, wherein said radial grooves are more than one-half the radial dimension of said stator.

11. An isolator accordance with claim 10, wherein said hole in said walls of said stator include a sloping surface connecting said radial grooves to said housing.

12. An isolator accordance with claim 11, wherein said hole and said sloping surface are elongated.

13. An isolator accordance with claim 12, wherein said hole and said sloping surface are milled in said walls of said stator.

14. An isolator accordance with claim 9, wherein the inside diameter of said stator is proportional to the shaft diameter.

15. An isolator accordance with claim 14, wherein the proportion between said stator and said shaft is 0.005 inches per inch of shaft diameter.

16. An isolator accordance with claim 12, wherein said hole in said stator is elongated circumferentially.

17. An isolator mechanism for use with a housing having a bearing with lubricant in the housing and a shaft protruding through the housing, to isolator comprising:
a) a stator affixed to the housing and surrounding the shaft;
b) said stator having a radial groove formed therein with the walls of said groove extending between said housing and said shaft;
c) the exterior surface of a first wall of said cavity facing the interior of the housing;
d) a plurality of axial holes in said first wall at the extremity of said first wall from said shaft connecting said groove to said housing.

18. An isolator mechanism for use with the housing having a bearing with lubricant in the housing and a shaft protruding though the housing, the isolator comprising:
a) a stator affixed to the housing and surrounding the shaft;
b) said stator having a radial groove formed therein with the walls of said grooves extending between said housing and said shaft;
c) the exterior surface of the first wall of said groove facing the interior of the housing;
d) an axial hole in said first wall at the extremity of said first wall from said shaft connecting said groove to said cavity;
e) a rotor affixed to said shaft and rotating therewith interfacing with said stator.

19. An isolator accordance with claim 18, wherein said hole in said first wall of said stator includes a sloping surface connecting said radial groove to said housing.

20. An isolator in accordance with claim 18, wherein said radial groove is more than one-half the radial dimension of said stator.

21. An isolator in accordance with claim 19, wherein said hole and said sloping surface are elongated.

22. An isolator in accordance with claim 19, wherein said hole and said sloping surface are milled in said first wall.

23. An isolator in accordance with claim 18, wherein the inside diameter of said stator is proportional to the shaft diameter.

24. An isolator in accordance with claim 18, wherein the interface between the rotor and stator includes an ejection port for ejection of contaminants from the exterior without reaching the housing.

25. An isolator in accordance with claim 24, wherein the contaminants are expelled by the pumping action between the rotor and the stator.

26. An isolator in accordance with claim 18, wherein said rotor surrounds said stator and prohibits the entry or exit and subsequent contaminants.
